(19) United States
(12) Patent Application Publication
(10) Pub. No.: US 2023/0262450 A1
(43) Pub. Date: Aug. 17, 2023

(54) METHOD AND APPARATUS FOR TRANSFERRING AND STORING ACTIVATION CODE FOR ESIM DEVICE CHANGE

(71) Applicant: Samsung Electronics Co., Ltd., Suwon-si (KR)

(72) Inventors: Sujung KANG, Suwon-si (KR); Kangjin YOON, Suwon-si (KR); Duckey LEE, Suwon-si (KR)

(21) Appl. No.: 18/169,772

(22) Filed: Feb. 15, 2023

(30) Foreign Application Priority Data
Feb. 17, 2022 (KR) 10-2022-0020884

(51) Int. Cl. H04W 8/24; H04W 28/02

(52) U.S. Cl. CPC H04W 8/24; H04W 28/0215

(57) ABSTRACT

The disclosure relates to a 5G or 6G communication system for supporting a higher data transmission rate. The disclosure relates to a method and an apparatus for installing and managing an eUICC profile. The method comprises: receiving, from a terminal through the transceiver, a message comprising capability information indicating whether a device change function is supported; determining that the terminal supports a device change, based on the capability information indicating that the device change function is supported; and transmitting, to the terminal through the transceiver, metadata comprising a device change configuration based on a determination that the terminal supports the device change.

### CROSS-REFERENCE TO RELATED APPLICATION

This application is based on and claims priority under 35 U.S.C. § 119 to Korean Patent Application No. 10-2022-0020884, filed on Feb. 17, 2022, in the Korean Intellectual Property Office, the disclosure of which is herein incorporated by reference in its entirety.

### BACKGROUND

### 1. Field

The disclosure relates to a method and an apparatus for installing and managing an embedded universal integrated circuit card (eUICC) profile.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

A “universal integrated circuit card (UICC),” which is also called a UICC card, is a smart card used by being inserted into a mobile communication terminal, etc. The UICC may include an access control module for accessing a network of a mobile operator by a terminal. Examples of the access control module include a universal subscriber identity module (USIM), a subscriber identity module (SIM), an IP multimedia service identity module (ISIM), and the like. A UICC including the USIM is commonly called a USIM card. Likewise, in general, a UICC including the SIM module is also called a SIM card.

Among the UICC cards, the UICC used as being fixed in a terminal is referred to as an embedded UICC (eUICC), and generally, the eUICC is fixed to the terminal, and means a UICC card capable of remotely downloading and selecting a SIM module. In addition, downloaded SIM module information is collectively referred to as an eUICC profile, or more simply, a profile.

The above information is presented as background information only to assist with an understanding of the disclosure. No determination has been made, and no assertion is made, as to whether any of the above might be applicable as prior art with regard to the disclosure.

### SUMMARY

The disclosure is to effectively provide a communication service in a mobile communication system.

An embodiment of the disclosure may provide a method and an apparatus for selecting a communication service and connecting to a network by a terminal in a communication system.

An embodiment of the disclosure may provide a method and an apparatus for downloading a profile via online and installing and managing the same, for connection to a network by a terminal in a communication system.

An embodiment of the disclosure may provide a method and an apparatus, in which a profile installed by a terminal for connection to a network is effectively downloaded again by another terminal in a communication system.

The technical subjects pursued in the disclosure may not be limited to the above-mentioned technical subjects, and other technical subjects which are not mentioned may be clearly understood, through the following descriptions, by those skilled in the art to which the disclosure pertains.

According to an embodiment of the disclosure for solving the problems above, a method of a profile server includes receiving, from a terminal, a message including capability information indicating whether a device change function is supported, identifying that the terminal supports a device change, based on capability information indicating whether the device change function is supported, and transmitting metadata including a device change configuration to the terminal in case that supporting of the device change by the terminal is identified.

According to another embodiment of the disclosure, a method of a terminal includes transmitting, to a profile server, a message including capability information indicating whether a device change function is supported, and receiving metadata including a device change configuration from the profile server in case that supporting of a device change by the terminal is identified, based on the capability information indicating whether the device change function is supported.

According to another embodiment of the disclosure, a profile server includes a transceiver and a controller configured to perform control to receive, from a terminal through the transceiver, a message including capability information indicating whether a device change function is supported, identify that the terminal supports a device change, based on capability information indicating whether the device change function is supported, and transmit metadata including a device change configuration to the terminal through the transceiver in case that supporting of the device change by the terminal is identified.

According to another embodiment of the disclosure, a terminal includes a transceiver and a controller configured to perform control to transmit, to a profile server through the transceiver, a message including capability information indicating whether a device change function is supported, and receive metadata including a device change configuration from the profile server through the transceiver in case that supporting of a device change by the terminal is identified, based on the capability information indicating whether the device change function is supported.

According to an embodiment of the disclosure, services can be effectively provided in a mobile communication system.

According to an embodiment, a terminal in a communication system may receive an activation code to initially install a profile, the activation code being issued by an operator or a profile server. When information for profile reinstallation is additionally added in the activation code and received, a terminal supporting a device change may store and carry the received profile reinstallation information, and provide the terminal for transferring and installing the profile with the corresponding profile reinstallation information or information regenerated using the corresponding information when a transfer request for the corresponding installed profile is input at a specific time point. If necessary, the terminal may first delete the profile to be transferred, and transfer a profile deletion proof which can prove deletion of the profile to the server. The terminal may provide a terminal for transferring and installing the profile with the information for profile installation or the information regenerated using the corresponding information (in this disclosure, the information for profile reinstallation or the information regenerated using the corresponding information is referred to as an activation code for device change) only when a normal response of a server is received. Another terminal having received the activation code for device change may transmit the device change activation code to the profile server and efficiently download and install the profile as a result of the transmission.

According to an embodiment of the disclosure, in a case where a profile server in a communication system receives an activation code for installation of a profile in a terminal from the terminal, additional device change support information is included in the corresponding activation code, the profile server may respond with a request for storing an activation code used for profile downloading, as information on a profile to be downloaded, to transfer the corresponding profile to another terminal and reinstall the same, and may perform processing so that the terminal stores the corresponding activation code as information which can be used during the device change. Thereafter, when the profile server receives a request for profile reinstallation in another terminal at a specific time point, the profile server may transmit, if necessary, a request for identifying whether profile transfer is possible to an operator, request a character string or an identification number of user authentication from the terminal, identify, if necessary, whether a result of a profile deletion proof has been received from the terminal, configure and prepare, if necessary, the state of a prepared profile as a download impossible state, verify, if necessary, whether the terminal has deleted the profile, change the state of the profile to a downloadable state when the verification has been successfully performed, and identify the received activation code to prevent profile copying and an error in the terminal, thereby safely processing profile downloading in another terminal.

Advantageous effects obtainable from the disclosure may not be limited to the above-mentioned effects, and other effects which are not mentioned may be clearly understood, through the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method of connecting to a mobile communication network by a terminal by using a UICC equipped with a fixed profile according to an embodiment of the present disclosure;

FIG. 2 illustrates a configuration of a system in which a terminal manages a profile installed in a first terminal and installs the profile in a second terminal upon a user input according to an embodiment of the present disclosure;

FIG. 3 illustrates an example of a procedure among a first terminal, a second terminal, and a server, for downloading of a profile by the second terminal according to an embodiment of the present disclosure;

FIG. 4 illustrates elements of a terminal according to an embodiment of the present disclosure;

FIG. 5 illustrates a profile server according to an embodiment of the present disclosure; and

FIG. 6 illustrates a method for determining whether an activation code is stored and perform processing in a case of performing updating by a first terminal so that a device change is supported according to an embodiment of the present disclosure.

### DETAILED DESCRIPTION

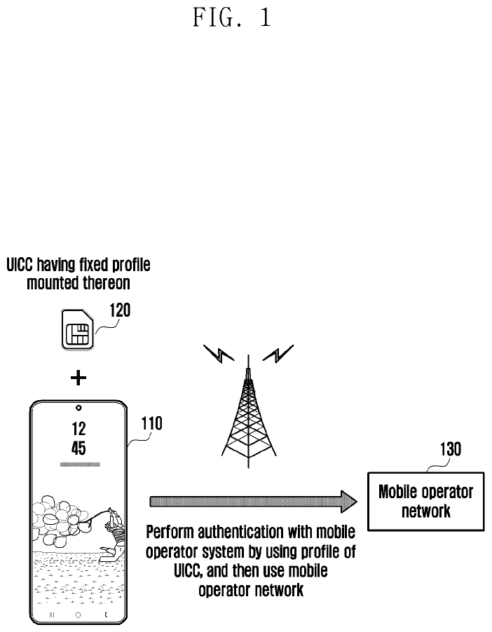

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card.

The specific terms as used herein are provided to assist in understanding the disclosure, and the use of these terms may be changed into other forms without departing from the technical idea of the disclosure.

In the disclosure, a “universal integrated circuit card (UICC)” is a smart card that is used by being inserted into a mobile communication terminal or the like, and is also referred to as a UICC card.

A UICC means a chip which stores personal information of a mobile communication subscriber, such as network access authentication information, a phone number list, and an SMS, and performs subscriber authentication and traffic security key generation when a connection is made to a mobile communication network such as GSM, WCDMA, and LTE, thereby enabling safe use of mobile communication.

The UICC may include a communication application or an access control module for access to a network of a mobile operator by a terminal. Examples of such a communication application or an access control module may include a universal subscriber identity module (USIM), a subscriber identity module (SIM), and an IP multimedia service identity module (ISIM), etc. In addition, the UICC may provide a higher-level security function for mounting of various applications such as an electronic wallet, ticketing, and an electronic passport.

The UICC including the USIM is usually also referred to as a USIM card. Likewise, the UICC including the SIM module is usually also referred to as a SIM card.

In the present disclosure, the terms “SIM card,” “UICC card,” “USIM card,” and “UICC including ISIM” may be used as the same/similar meaning. For example, the same description of the disclosure is applicable to the SIM card, the USIM card, the ISIM card, or a general UICC card.

The SIM card stores personal information of a mobile communication subscriber, and performs subscriber authentication and traffic security key generation during access to a mobile communication network, thereby enabling safe use of mobile communication.

In general, the SIM card is manufactured as a dedicated card for a specific mobile operator upon a request from the corresponding operator, and is released in a state where authentication information for access to a network of the corresponding operator, for example, a universal subscriber identity module (USIM) application and an international mobile subscriber identity (IMSI), a K value, an OPc value, or the like, is embedded in the card in advance. Therefore, the SIM card is delivered to the corresponding mobile operator, and then the corresponding mobile operator provides the same to a subscriber. Thereafter, if necessary, the corresponding mobile operator may perform management of applications in the UICC, such as installation, modification, and deletion of the applications, by using an over the air (OTA) technology, etc.

The subscriber can use the network of the corresponding mobile operator and application services by inserting the UICC card into his/her own mobile communication terminal, and when replacing the terminal with a new one, can use the authentication information, the mobile communication phone number, the personal phonebook, and the like stored in the UICC card, as they are in the new terminal by taking out the UICC card from the old terminal and inserting the same into the new terminal.

However, the SIM card causes inconvenience in receiving, by the mobile communication terminal user, a service provided from other mobile operators. The mobile communication terminal user experiences inconvenience in physically obtaining a SIM card to receive the service from the mobile operator. For example, when a user travels abroad, the user needs to purchase a local SIM card to receive a local mobile communication service, which causes inconvenience to the user. A roaming service may somewhat reduce the inconvenience, but there is a problem in that the user needs to pay a relatively high rate and cannot receive the service in a case where a contract is not established between mobile operators.

Such inconvenience may be mostly solved when the SIM module is remotely downloaded and installed in the UICC card. That is, the SIM module for a mobile communication service to be used may be downloaded to the UICC card at the time desired by a user. Such UICC card may be used in a method of downloading and installing multiple SIM models, and selecting only one of the SIM modules. The UICC card may be fixed or may not be fixed in a terminal. In particular, the UICC fixed in a terminal is referred to as an embedded UICC (eUICC), and generally, the eUICC is fixed to the terminal, and means a UICC card capable of remotely downloading and selecting a SIM module. In the disclosure, the UICC card capable of remotely downloading and selecting the SIM module is referred to as an eUICC. That is, a UICC card that is fixed or not fixed in a terminal, among the UICC cards capable of remotely downloading and selecting the SIM module, is collectively referred to as an eUICC. In addition, downloaded SIM module information is collectively referred to as an eUICC profile, or more simply, a profile.

In the present disclosure, an “embedded UICC (eUICC)” is a security module that is in a form of a chip embedded in a terminal, rather than a detachable security module that can be inserted into and detached from a terminal. The eUICC may download and install a profile by using an over the air (OTA) technology. The eUICC may be referred to as a UICC capable of downloading and installing a profile.

In the present disclosure, a method of downloading and installing a profile to an eUICC by using the OTA technology may also be applied to a detachable UICC that can be inserted into and detached from a terminal. That is, embodiments of the disclosure may be applied to a UICC capable of downloading and installing a profile by using the OTA technology.

In the disclosure, the term “UICC” may be interchangeably used with the term “SIM,” and the term “eUICC” may be interchangeably used with the term “eSIM.”

A “profile” in this disclosure may mean a thing in which an application, a file system, an authentication key, etc. to be stored in a UICC are packaged in a software format.

A “USIM profile” in this disclosure may have the same meaning as the “profile,” or may mean a thing in which information included in a USIM application in a profile is packaged in a software format.

In the present disclosure, an operation in which a terminal enables a profile may mean an operation of changing the state of a corresponding profile to an enabled state and making a configuration so that the terminal can receive a communication service through the mobile operator having provided the profile. The profile in the enabled state may be represented as an “enabled profile.”

In the present disclosure, an operation in which a terminal disables a profile may mean an operation of changing the state of a corresponding profile to a disabled state and making a configuration so that the terminal cannot receive a communication service through the mobile operator having provided the profile. A profile in the disabled state may be represented as a “disabled profile.”

In the present disclosure, an operation in which a terminal deletes a profile may mean an operation of changing the state of a corresponding profile to a deleted state and making a configuration so that the terminal can no longer enable or disable the corresponding profile. A profile in the deleted status may be represented as a “deleted profile.”

In the present disclosure, an operation in which the terminal enables, disables, or deletes a profile may mean an operation of, instead of immediately changing the state of each profile to an enabled state, a disabled state, or a deleted state, first only marking the state of each profile as a to-be-enabled state, a to-be-disabled state, or a to-be-deleted state, and changing the state of each profile to an enabled state, a disabled state, or a deleted state after the terminal or the UICC of the terminal performs a specific operation (e.g., performing a refresh or reset command). An operation of marking the state of a specific profile as a scheduled state (e.g., a to-be-enabled state, a to-be-disabled state, or a to-be-deleted state) is not necessarily limited to displaying one scheduled state for one profile, and may include displaying the respective states of one or more profiles as the same scheduled state or different scheduled states, displaying the state of one profile as one or more scheduled states, or displaying the respective states of one or more profiles as the same or different one or more scheduled states.

In addition, when the terminal displays one or more scheduled states for a random profile, the displays of two scheduled states may be integrated into one. For example, when the state of a random profile is displayed as a to-be-disabled state and a to-be-deleted state, the state of the corresponding profile may be integrated and displayed as a to-be-disabled-and-deleted state.

In addition, an operation in which the terminal displays a scheduled state for one or more profiles may be sequentially or simultaneously performed. Furthermore, an operation in which the terminal displays a scheduled state for one or more profiles and then changes the actual state of a profile may be sequentially or simultaneously performed.

In the present disclosure, a “profile provision server” may include a function of generating a profile, encrypting the generated profile, generating a profile remote management command, or encrypting the generated profile remote management command. The profile provision server may be expressed as a subscription manager data preparation (SM-DP), a subscription manager data preparation plus (SM-DP+), an off-card entity of profile domain, a profile encryption server, a profile generation server, a profile provisioner (PP), a profile provider, or a profile provisioning credentials holder (PPC holder).

In the present disclosure, a “profile management server” may include a function of managing a profile. The profile management server may be expressed as a subscription manager secure routing (SM-SR), a subscription manager secure routing plus (SM-SR+), an off-card entity of eUICC profile manager, a profile management credentials holder (PMC holder), an eUICC manager (EM), a profile manager (PM) or the like.

In the present disclosure, the profile provision server may mean a server having a function of a profile management server combined together. Therefore, in various embodiments of the disclosure, an operation of the profile provision server may also be performed by the profile management server. Likewise, an operation of the profile management server or the SM-SR may also be performed by the profile provision server.

In the present disclosure, an “opening mediation server” may be expressed as a subscription manager discovery service (SM-DS), a discovery service (DS), a root SM-DS, and an alternative SM-DS. The opening mediation server may receive an event registration request (register event request or event register request) from one or more profile provision servers or opening mediation servers. In addition, the one or more opening mediation servers may be complexly used, wherein a first opening mediation server may receive an event registration request from a second opening mediation server as well as the profile providing server.

In the present disclosure, the profile provision server and the opening mediation server may be collectively referred to as a “remote SIM provisioning (RSP) server.” The RSP server may be expressed as a subscription manager XX (SM-XX).

In the present disclosure, the term “terminal” may be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmission/reception unit (WTRU), a mobile node, a mobile, or other terms. In an embodiment, the terminal may include a cellular phone, a smartphone having a wireless communication function, a personal digital assistant (PDA) having a wireless communication function, a wireless modem, a portable computer having a wireless communication function, a photographing device having a wireless communication function, such as a digital camera, a gaming device having a wireless communication function, music storage and reproduction home appliances having a wireless communication function, Internet home appliances capable of performing wireless Internet access and browsing, and portable units or terminals having integrated combinations of such functions above. Furthermore, the terminal may include, but is not limited to, a machine to machine (M2M) terminal and a machine type communication (MTC) terminal/device. In the disclosure, the terminal may be referred to as an electronic device.

In the present disclosure, an “electronic device” may have a UICC embedded therein, the UICC capable of downloading and installing a profile. If the UICC is not embedded in the electronic device, the UICC physically separated from the electronic device may be connected to the electronic device by being inserted into the electronic device. For example, the UICC may be inserted into the electronic device in the form of a card. The electronic device may include the terminal. In this case, the terminal may be a terminal including the UICC capable of downloading and installing a profile. The UICC may be embedded in the terminal, and may also be inserted into the terminal so as to be connected to the terminal if the UICC is separated from the terminal. The UICC capable of downloading and installing a profile may be referred to as, for example, an eUICC.

In the present disclosure, the terminal or the electronic device may include software or an application installed in the terminal or the electronic device to control the UICC or the eUICC. The software or application installed in the terminal or the electronic device for control of the UICC or the eUICC may be referred to as, for example, a local profile assistant (LPA).

In the present disclosure, a “profile delimiter” may be referred to as a profile ID, an integrated circuit card ID (ICCID), a matching ID, an event identifier (event ID), an activation code, an activation code token, a command code, a command code token, a signed command code, an unsigned command code, or a factor matching an ISD-P or a profile domain (PD). The profile ID may indicate a unique identifier of each profile. The profile delimiter may further include an address of a profile provision server (SM-DP+) capable of indexing a profile. In addition, the profile delimiter may further include a signature of the profile provision server (SM-DP+). The activation code token is information referring to subscription information, and may be included as information included in an activation code, and transmitted, and the RSP server may use the activation code token and EventID as a matching ID.

In the present disclosure, an “eUICC identifier (eUICC ID)” may be a unique identifier of the eUICC embedded in the terminal, and may be referred to as an EID. In addition, If a provisioning profile is pre-embedded in the eUICC, the eUICC identifier (eUICC ID) may be a profile ID of the corresponding provisioning profile. If, as in an embodiment of the disclosure, the terminal and the eUICC chip are not separated from each other, the eUICC identifier (eUICC ID) may be a terminal ID. In addition, the eUICC ID may also refer to a specific secure domain of the eUICC chip.

In the present disclosure, a “profile container” may be referred to as a profile domain. The profile container may be a security domain.

In the present disclosure, an “application protocol data unit (APDU)” may be a message for interworking between the terminal and the eUICC. The APDU may be a message for interworking between a profile provider (PP) or a profile manager (PM) and the eUICC.

In the present disclosure, profile provisioning credentials (PPC) may be a means used for mutual authentication, profile encryption, and signing between the profile provision server and the eUICC. The PPC may include one or more of a symmetric key, a Rivest-Shamir-Adleman (RSA) certificate and private key, an elliptic curved cryptography (ECC) certificate and private key, and a root certification authority (CA) and certificate chain. In addition, if there are multiple profile provision servers, different PPCs for the multiple profile provision servers may be used for or stored in the eUICC.

In the present disclosure, profile management credentials (PMC) may be a means used for mutual authentication, transmission data encryption, and signing between the profile management server and the eUICC. The PMC may include one or more of a symmetric key, a RSA certificate and private key, an ECC certificate and private key, and a root CA and certificate chain. In addition, if there are multiple profile management servers, different PMCs for the multiple profile management servers may be used for or stored in the eUICC.

In the present disclosure, an “AID” may be an application identifier. This value may be a delimiter for distinguishing between different applications in the eUICC.

In the present disclosure, an “event” may be a term collectively referring to profile download, remote profile management, or other profile or eUICC management/process commands. The event may be referred to as a remote SIM provisioning operation (RSP operation) or an event record, and each event may be referred to as data including one or more of an event identifier (event ID, EventlD) or a matching identifier (matching ID, MatchinglD) corresponding to the event, an address (FQDN, ID address, or URL) of the profile provision server (SM-DP+) or the opening mediation server (SM-DS) where the corresponding event is stored, a signature of the profile provision server (SM-DP+) or the opening mediation server (SM-DS), and a digital certificate of the profile provision server (SM-DP+) or the opening mediation server (SM-DS).

The data corresponding to the event may be referred to as a “command code.” A part or the entirety of a procedure using the command code may be referred to as a “command code processing procedure,” a “command code procedure,” or a local profile assistant application programming interface (LPA API).” The profile download may be interchangeably used with a profile installation.

In addition, an “event type” may be used as a term indicating whether a specific event is a profile download, remote profile management (for example, deletion, activation, deactivation, replacement, update, and the like) or other profile or eUICC management/process commands, and may be referred to as an operation type (or OperationType), an operation class (or OperationClass), an event request type, an event class, an event request class, and the like. For a random event ID (EventID or MatchingID), a purpose of use (EventID source or MatchingID source) or a path through which a terminal has obtained the event identifier (EventID or MatchingID) may be designated.

In the present disclosure, a “profile package” may be interchangeably used with a profile or used as a term indicating a data object of a specific profile, and may be referred to as a profile TLV or a profile package TLV. If the profile package is encrypted using an encryption parameter, the profile package may be referred to as a protected profile package (PPP) or a protected profile package TLV (PPP TLV). If the profile package is encrypted using an encryption parameter that can be decrypted by a specific eUICC only, the profile package may be referred to as a bound profile package (BPP) or a bundled profile package TLV (BPP TLV). The profile package TLV may be a data set expressing information constituting a profile in the TLV (tag, length, value) format.

In the present disclosure, a “local profile management (LPM)” may be referred to as profile local management, local management, a local management command, a local command, a local profile management package (LPM package), a profile local management package, a local management package, and a local management command package, a local command package. The LPM may be used for changing the state (enabled, disabled, deleted) of a specific profile through software etc. installed in the terminal, or changing (updating) contents (e.g., profile nickname, profile metadata, or the like) of a specific profile. The LPM may include one or more local management commands, and in this case, a profile subject to each local management command may be the same or different for each local management command.

In the present disclosure, a “remote profile management (RPM)” may be referred to as profile remote management, remote management, a remote management command, a remote command, a remote profile management package (RPM package), a profile remote management package, a remote management package, a remote management command package, and a remote command package. The RPM may be used as an application for changing the state (enabled, disabled, and deleted) of a specific profile, or changing (updating) contents (e.g., profile nickname, profile metadata, or the like) of a specific profile. The RPM may include one or more remote management commands, and in this case, a profile subject to each remote management command may be the same or different for each remote management command.

In the present disclosure, a “certificate” or a “digital certificate” may indicate a digital certificate used for mutual authentication based on an asymmetric key including a pair of a public key (PK) and a secret key (SK). Each certificate may include one or more public keys (PKs), a public key identifier (PKID) corresponding to each public key, an identifier (certificate issuer ID) of a certificate issuer (CI) issuing the corresponding certificate, and a digital signature.

In addition, a “certificate issuer” may be referred to as a certification issuer, a certificate authority (CA), or a certification authority, and the like.

In the present disclosure, the “public key (PK)” and the “public key identifier (PKID)” may be interchangeably used having the same meaning indicating a certificate including a specific public key or a corresponding public key, a part of a certificate including a part of a specific public key or a corresponding public key, a calculation result (for example, a hash) value of a specific public key or a calculation result (for example, a hash) value of a certificate including the corresponding public key, a calculation result (for example, a hash) value of a part of a specific public key or a calculation result (for example, a hash) value of a part of the certificate including the corresponding public key, or a storage space in which data is stored.

In the present disclosure, if certificates (primary certificates) issued by one certificate issuer are used for issuing another certificate (secondary certificate), or the secondary certificates are used for issuing tertiary or higher certificates, a correlation of the corresponding certificates may be referred to as a certificate chain or a certificate hierarchy, and in this case, a CI certificate used for initial certificate issuance may be referred to as a root of certificate, the highest certificate, a root CI, a root CI certificate, a root CA, a root CA certificate, and the like.

In the present disclosure, a “mobile operator” may indicate a business entity that provides a communication service to a terminal, and a business supporting system (BSS), an operational supporting system (OSS), a point of sale terminal (POS terminal), and other IT systems of a mobile operator may be collectively referred to as a mobile operator. In addition, in the disclosure, the mobile operator is not limited to a term representing only one specific business entity that provides communication services, but may be used as a term referring to a group or association (or consortium) of one or more businesses entities or a representative representing the group or association. In addition, in the disclosure, a mobile operator may be referred to as an operator (or OP or Op.), a mobile network operator (MNO), a mobile virtual network operator (MVNO), a service provider (or SP), a profile owner (PO), and the like, and each mobile operator may configure or receive an allocation of at least one name and/or object identifier (OID) of the mobile operator. If a mobile operator refers to a group, association, or representative of one or more business entities, a name or an object identifier of any group, association, or representative may be a name or an object identifier shared by all business entities belonging to the group or the association, or all business entities cooperating with the representative.

In the present disclosure, an “AKA” may indicate an authentication and key agreement, and may indicate an authentication algorithm for accessing 3GPP and 3GPP2 networks.

In the present disclosure, “K” is an encryption key value stored in the eUICC used in the AKA authentication algorithm.

In the present disclosure, “OPc” is a parameter value that can be stored in the eUICC used in the AKA authentication algorithm.

In the present disclosure, an “NAA” is a network access application program, and may be an application program stored in a UICC, such as a USIM or an ISIM for accessing a network. The NAA may be a network connection module.

In the present disclosure, an “indicator” may be used to represent necessity or unnecessity of a random function, configuration, or operation, or may be used to represent the corresponding function, configuration, or operation itself. In addition, in the disclosure, the indicator may be expressed in various forms, such as an alphanumeric string, an operator indicating true/false (Boolean—TRUE or FALSE), a bitmap, an array, and a flag, and may be interchangeably used with other expressions having the same meaning.

In a wireless communication system according to an embodiment of the disclosure, a terminal for managing a profile for connecting to a network by using an embedded universal integrated circuit card (eUICC) may include a transceiver, and at least one processor which controls the terminal to receive an input of a transfer request of the profile, identify profile transfer information, transmit, to a profile server, a message requesting profile request, further transmit, to the profile server, a character string or an identification number for user authentication if necessary, receive, from the profile server, an activation code or whether an event is registered and the profile needs to be deleted, delete the profile, transmit, to the profile server, a result of the deletion of the profile, transfer the activation code or the profile transfer request result to another terminal, receive the activation code or the profile transfer request transferred from another terminal, transmit a message requesting a profile to the profile server by using the activation code, receive a profile package from the profile server, and install the profile package.

In a wireless communication system according to an embodiment, a profile server for providing a terminal with a profile for network connection may include a transceiver and at least one processor which controls the profile server to receive a transfer request message of the profile, further receives a character string or an identification number for user authentication from the terminal to the profile server if necessary, determine whether the profile is transferrable, generate an activation code which can download the profile or a new profile, configure the state of a prepared profile as a download impossible state when the transfer is possible after deletion of the profile from the terminal, transmit the activation code and whether the profile needs to be deleted to the terminal, receive a result of the profile deletion from the terminal, change the state of the profile to a downloadable state, receive a profile download request message from the terminal, determine whether the state of the profile is a downloadable state, transmit a profile package to the terminal when the state of the profile is the downloadable state, transmit an error code or verify the profile deletion result included in the profile download request when the state of the profile is the download impossible state, and transmit the error code if there is no profile deletion result or the verification has failed.

An embodiment of the present disclosure relates to a method and an apparatus for transferring a profile corresponding to subscriber information from a first terminal to a second terminal by a terminal equipped with an eUICC, and using the same. Specifically, to this end, an embodiment of the disclosure provides a method and an apparatus in which with reference to an activation code used in a process of processing downloading of a first profile, a profile server transmits information for processing of a device change of the first profile to a first terminal in the process of the downloading of the first profile, or transmit a message indicating storage of an activation code suggested during the downloading, for the use during processing of a device change, so as to cause the first terminal to store the corresponding activation code and store the received device change information, configures again an activation code by using the information stored by the first terminal and provide the same to a second terminal, so as to enable the second terminal to download the profile corresponding to the first profile.

An embodiment of the present disclosure may include determining, by an operator or a server, whether to additionally generate profile reinstallation information required for a device change during profile download processing of a first terminal, so as to provide the same, performing processing by acquiring predetermined information required for the device change from the operator or the server by the first terminal, transferring information for reinstallation of a profile from the first terminal to a second terminal, and downloading the profile from the server and installing the same by using information for reinstallation of the corresponding profile reinstallation, received from the second terminal.

A method for processing of transfer of subscriber information in a wireless communication system according to an embodiment of the disclosure may include receiving an input of an activation code including device change support information by a terminal, suggesting the profile activation code to a profile server and receiving predetermined information for a device change from the profile server as a response to the profile activation code, generating an activation code for device change processing, based on the received device change information, and transmitting the generated code to another terminal and providing the same to another terminal so that another terminal can download the profile from the profile server, based on the corresponding input activation code.

According to an embodiment of the present disclosure, a terminal in a communication system may receive an activation code to initially install a profile, the activation code being issued by an operator or a profile server, and when information for profile reinstallation is additionally added in the activation code and received, a terminal supporting a device change may store and carry the received profile reinstallation information, and provide the terminal for transferring and installing the profile with the corresponding profile reinstallation information or information regenerated using the corresponding information when a transfer request for the corresponding installed profile is input at a specific time point. If necessary, the terminal may first delete the profile to be transferred, transfer a profile deletion proof which can prove deletion of the profile to the server, and provide a terminal for transferring and installing the profile with the information for profile installation or the information regenerated using the corresponding information (in this disclosure, the information for profile reinstallation or the information regenerated using the corresponding information is referred to as an activation code for device change) only when a normal response of a server is received. Another terminal having received the activation code for device change may transmit the device change activation code to the profile server and efficiently download and install the profile as a result of the transmission.

According to an embodiment of the present disclosure, in a case where a profile server in a communication system receives an activation code for installation of a profile in a terminal from the terminal, additional device change support information is included in the corresponding activation code, the profile server may respond with a request for storing an activation code used for profile downloading, as information on a profile to be downloaded, to transfer the corresponding profile to another terminal and reinstall the same, and may perform processing so that the terminal stores the corresponding activation code as information which can be used during the device change. Thereafter, when the profile server receives a request for profile installation in another terminal at a specific time point, the profile server may transmit, if necessary, a request for identifying whether profile transfer is possible to an operator, request a character string or an identification number of user authentication from the terminal, identify, if necessary, whether a result of a profile deletion proof has been received from the terminal, configure and prepare, if necessary, the state of a prepared profile as a download impossible state, verify, if necessary, whether the terminal has deleted the profile, change the state of the profile to a downloadable state when the verification has been successfully performed, and identify the received activation code to prevent profile copying and an error in the terminal, thereby safely processing profile downloading in another terminal.

Hereinafter, a method and an apparatus for installing and managing a profile of the disclosure will be described with reference to FIGS. 1 to 6.

FIG. 1 illustrates a method of connecting to a mobile communication network by a terminal by using a UICC equipped with a fixed profile according to an embodiment of the present disclosure.

As shown in FIG. 1, a UICC 120 may be inserted into a terminal 110. For example, the UICC 120 may be a detachable type or may be pre-embedded in the terminal.

With regard to the UICC 120 equipped with the fixed profile, the fixed profile indicates that “access information” enabling access to a specific mobile operator is fixed. For example, the access information may be an IMSI that is a subscriber delimiter and a K or Ki value required to authenticate a network, together with the subscriber delimiter.

The terminal 110 according to various embodiments may perform authentication with an authentication processing system (for example, a home location register (HLR) or AuC) of a mobile operator, by using the UICC 120. For example, an authentication process may be an authentication and key agreement (AKA) process. When the authentication is successful, the terminal may use a mobile communication service, such as using a phone call or mobile data, by using a mobile operator network 130 of a mobile communication system.

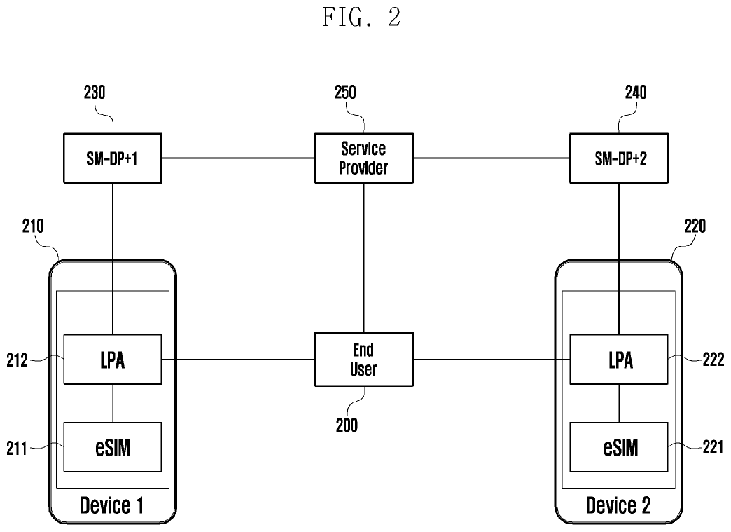

FIG. 2 illustrates a configuration of a system in which a terminal manages a profile installed in a first terminal and installs the profile in a second terminal upon a user input according to an embodiment of the present disclosure.

As illustrated in FIG. 2, a terminal 210 or 220 may have an eSIM 211 or 221 mounted thereon, and the eSIM 211 or 221 may have a profile (not shown) installed therein. In addition, the terminal 210 or 220 may have an LPA 212 or 222 installed therein. The eSIM 211 or 221 may be controlled by the LPA 212 or 222. A user 200 may control a profile installed in the eSIM 211 or 221 of each terminal 210 or 220 through the LPA 212 or 222.

The user 200 may receive a communication service from a service provider 250 (hereinafter, referred to as a “mobile operator” or an “operator”). To this end, the terminal 210 may have a profile (not shown) of the business operator 250 installed therein. When newly purchasing a new second terminal 220, the user may attempt to install a profile installed in a first terminal 210 again.

The business operator 250 may be connected to a first profile server 230 and a second profile server 240, the LPA 212 of the first terminal 210 may be connected to a first profile server 230, and the LPA 222 of the second terminal 220 may be connected to a second profile server 240. In this case, the first profile server 230 and the second profile server 240 may be the same or may be different from each other. In addition, when one or more business operator servers are included in the configuration, the business operator servers may be connected to respective separate profile servers, respectively, and the one or more business operator servers may be connected to the same profile server. In addition, for convenience of description, FIG. 2 illustrates a case in which each of the profile servers 230 and 240 is configured as a single server, but according to implementation and an embodiment, one or more profile servers (SM-DP+) may be included as server configuration. It should be noted that the configuration of various servers may be simply indicated as a single profile server.

A detailed operation and a message exchange procedure of the user 200, the business operator 250, the terminals 210 and 220, the eSIMs 211 and 221, the LPAs 212 and 222, and the profile servers 230 and 240 will be described below with reference to the following drawings.

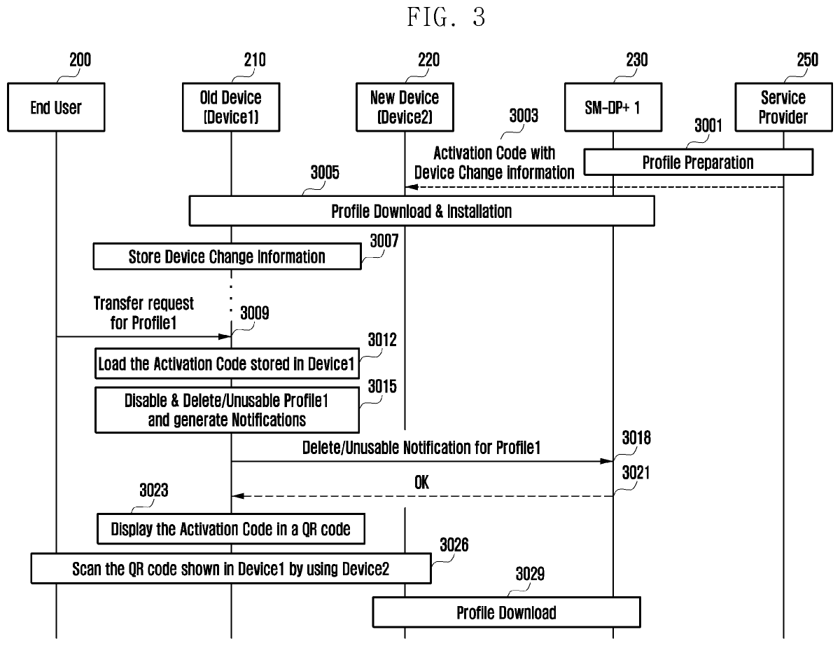

FIG. 3 illustrates an example of a procedure among a first terminal, a second terminal, and a server, for downloading of a profile by the second terminal according to an embodiment of the present disclosure.

According to an embodiment, as illustrated in FIG. 3, in a process of installing a profile by a first terminal 210, an activation code including information on device change support may be transmitted to a server 230. The first terminal 210 may receive and store device change support information replied as information transmitted to the profile server 230. Thereafter, in a case where a device change request is received at a specific time point and the device change is performed, when the stored device change information is required, to perform processing of a device change from the installed first profile to a second terminal 220, after processing the first profile to be in a deleted or unusable state, the first terminal 210 may transmit, to the profile server 230, information on a result of the processing of the first profile to be in the deleted or unusable state. When a normal response is received from the profile server 230, the first terminal 210 may generate an activation code and transmit the same to the second terminal 220. In this case, the second terminal 220 may request downloading of a profile from the profile server 230. The profile server 230 may verify the activation code received from the second terminal 220, and may additionally verify, if necessary, information on the processing of the first profile to be in the deleted or unusable state, transferred by the first terminal 210. A profile prepared for transfer of the profile to the second terminal 220 by the profile server 230 may be downloaded, and the second terminal 220 may download and install the same to process the device change of the first profile.

Specifically, the configuration and description of a user 200, the first terminal 210, the second terminal 220, the profile server 230, and the operator 250 of FIG. 3 refer to FIG. 2. For example, the user 200, the first terminal 210, the second terminal 220, the profile server 230, and the operator 250 may correspond to the user 200, the first terminal 210, the second terminal 220, the first profile server 230, and the operator 250, respectively.

Referring to FIG. 3, in operation 3001, the operator 250 may request profile preparation for the first terminal 210 from the profile server 230. For example, for the profile preparation request, the operator 250 may perform a contract for a service to be provided through a corresponding profile with the user 200. The user 200 may select a service provided by the operator 250 through the first terminal 210, makes a service contract with the operator, and purchase a profile corresponding thereto. According to an embodiment, the operator 250 may request profile preparation from the profile server 230 by using an ES2+.DownloadOrder function and an ES2+.ConfirmOrder function.

In operation 3001, the profile server 230 may prepare a profile to be transferred to the first terminal 210. The profile server 230 or the operator 250 may assign and manage a matching identifier (ID) corresponding to the prepared profile. When the operator 250 includes a confirmation code for profile downloading or a confirmation code for profile transfer in the profile preparation request, the profile server 230 may store the corresponding confirmation code to correspond to the prepared profile. When storing the corresponding confirmation code, the profile server 230 may store the corresponding confirmation code without change, or may selectively generate a hash value of the confirmation code. The hash may use an algorithm such as secure hash algorithm (SHA)-0, SHA-1, and SHA-256.

In operation 3001, the profile server 230 or the operator 250 may generate an activation code for profile downloading and transfer the same to the user 200. The activation code include at least one of a fully qualified domain name (FQDN) of an address of the profile server 230, in which the profile is prepared, a matching identifier, a profile download confirmation code required indicator (confirmation code required flag), a profile transfer confirmation code required indicator (confirmation code for device change required flag), a device change support indicator (device change support), and device change information (device change info). When the profile preparation request of the operator 250 includes the profile download confirmation code, the profile download confirmation code required indicator may be configured as “1” or “True.” In addition, when the profile preparation request of the operator 250 includes the device change information (device change info), a new activation code token value may be included and configured as device change information to be stored and used by an LPA (terminal) later for a device change.

In operation 3001, in addition, during transfer of the corresponding profile, when the first profile needs to be deleted before a second profile for the second terminal 220, to be prepared in the profile server 230 for transfer of the first profile, is transferred to the second terminal 220, the operator 250 may respond to the profile server 230 with a first profile deletion indicator (delete old profile). In addition, the operator 250 may transfer, to the profile server 250, information to be noted by a user who desires to transfer the first profile.

In operation 3001, according to an embodiment, the profile server 230 may selectively register an event corresponding to the prepared profile in an opening mediation server (not shown) accessible by the first terminal 210. The event registered in the opening medication server (not shown) may include at least one of an FQDN of an address of the profile server 230, in which the profile is prepared, and a matching identifier (or an event identifier) of the prepared file. The activation code including the device change information may have, for example, the following formats, and $ indicates a delimiter.

An example of the activation code including the device change information is 1$SM-DP+Address(profile server address)$AC_Token(activation code token as an example of a matching ID)$SM-DP+Oid(profile server identifier)$DeviceChangeSupport(device change support indication)$DeviceChangeInfo(predetermined information for a device change). In operation 3003, the first terminal 210 may download a profile prepared in the profile server 230 by using the activation code provided by the profile server 230 or the operator 250 or an event acquired from the opening mediation server (not shown). And install an eSIM (not shown and corresponding to 211 of FIG. 2) of the first terminal 210. According to this embodiment, as described above, the activation code provide to the terminal 210 may include at least one of the device change information (device change info) and/or the device change support indicator (device change support).

In operation 3005, the first terminal 210 may receive an input of the activation code acquired by the user 200, and initiate a profile download procedure. According to an embodiment, the first terminal 210 may transmit, to the profile server 230, capability information indication whether the first terminal 210 supports a device change function. In this case, the first terminal 210 may include the device change support indicator (device change support indication) in the profile download request, and transmit the same to the profile server 230. The first terminal 210 may include device change function support indication in device info and eUICC info and transmit the same to the profile server 230, and the first terminal 210 may perform transmission in one of the following methods according to a combination of versions (indicated as “v version number”) of the LPA and the eUICC installed in the first terminal 210.

In one example of method for a combination of v3 LPA and v2 eUICC, perform transmission by including corresponding information in device info and including support version information in eUICC.

In one example of method for a combination of v3 LPA and v3 eUICC, perform transmission by including corresponding information in device info and including support version information and device change support identification information in eUICC.

For example, the version follows the v2 or v3 standard of GSMA SGP.22, and when explicit standard information is included and transmitted to the profile server 230, the profile server 230 may also determine the version as corresponding standard information. For example, when the profile server 230 receives, from the first terminal 210, information indicating that at least one piece of version information corresponds to a specific version in the LPA or the eUICC, the profile server 230 may identify the at least one piece of version information in the LPA or the eUICC of the first terminal 210, based on the received information.

Alternatively, even though the version information is not explicitly included, the profile server 230 having a specific version, for example, a parameter included only in v3, e.g., lpaRSPCapablity, etc., may determine the version of the terminal. In addition, in a case of v3, for example, the profile server 230 may also determine whether a device change is supported, through lpaRSPCapability included in device info and eUICCRSPCapability included in eUICC info.

The profile server 230 having received the same may identify the device support identification information and the eUICC support version, and when the eUICC support version is v3 and the device change is supported, the profile server may prepare metadata of a profile for processing downloading by including predetermined information for the device change in the metadata, and allow the same to be downloaded. According to an embodiment, the profile server 230 may transmit, to the first terminal 210, both a new activation code to be used for the device change and a command for storing the corresponding activation code in the terminal, or may transmit, to the first terminal 210, a command for storing an activation code used for the profile server by the LPA for the existing profile downloading.

In addition, the profile server 230 may prepare a profile package so as to be used when there is a download request corresponding to a corresponding profile downloaded by another terminal later, and may map the profile package to be used later for a device change and AC_token and store the same. The AC_token may be AC_token included a newly generated AC or the existing AC.

When the eUICC support version is v3 and the device change is not supported, the profile server 230 may make determination according to one of the following methods and perform processing.

In one example of method for recognizing the first terminal 210 as a terminal not supporting a device change, not including information on the device change in profile information (metadata or elementary file), transmitting the same to the first terminal 210, and completing a profile download procedure.

In one example of method, when the LPA version is v3 and the device change support identification information is included in device info and received, recognizing the same as a combination of the v3 LPA and the v3 eUICC, and during profile downloading, transmitting, to the first terminal 210, both a new activation code to be used for the device change and a command for storing the corresponding activation code in the terminal, or transmitting, to the first terminal 210, a command for storing an activation code used for the profile server by the LPA for the existing profile downloading.

In operation 3007, the first terminal 210 may store information for processing a device change. The storage of information may be performed after the first terminal 210 successfully performs the profile downloading and then successfully transfer a profile installation result. The stored information for processing a device change may include the previously received device change information included in an activation code provided in operation 3003 or a response of the profile server 230 in operation 3005, for example, an indicator for storage and reuse of the existing activation code, new activation code information, information on storage and use of the corresponding activation code, etc. The first terminal 210 may store the corresponding information in a storage space (not shown) of the eUICC (not shown) of the first terminal 210 or the terminal 210 other than the eUICC. A method for determining whether there is information on the device change, to be stored by the first terminal 210, may include making determination through whether the activation code includes an indicator (e.g., meaning that storage is required) usable during the device change, or whether a response message for processing of the profile downloading by the profile server 230 includes predetermined information including that a device change from the corresponding terminal to another terminal is possible later. The corresponding predetermined information may selectively include at least one of an activation code (AC) corresponding to a second profile (profile 2), a profile deletion indicator (delete profile flag), an event registration indicator (event registration flag), and information on storage of an activation code suggested during downloading of a first profile (profile 1), for the device change.

An example of the response message including the information may be a response message of the profile server 230 to a terminal authentication request (authenticate client) message, or profile metadata as profile information. Alternatively, the response message may be a value provided as elementary file EFDCC under DFGSMA in a profile in an installation profile package, to be included in the response message and downloaded.

As a method for storing the device change information, in operation 3005, the first terminal 210 may store an activation code used for profile downloading, or extract only device change information among information of the corresponding activation code and then generate and store a new activation code format. For example, when an initially received activation code has the same format as the “existing” activation code below, the terminal may extract an AC_Token value from DeviceChangeInfo of the “existing” activation code, substitute AC_Token, and then store the activation code in a new activation code format as in the following example in the “generated” activation code below.

Existing activation code format: 1$SM-DP+Address$AC_Token$SM-DP+Oid$DeviceChangeSupport$DeviceChangeInfo

Generated activation code format: 1$SM-DP+Address$New AC_Token(extract from DeviceChangelnfo and perform sub stitution)$SM-DP+Oid

In operation 3009, the user 200 may request, from the first terminal 210, transfer of the first profile downloaded in operations 3005 and 3007. To this end, the user 200 may identify summary information on the first profile (profile metadata) and information to be noted by the user 200 who desires to transfer the first profile, through the first terminal 210. The information on the first profile and the information to be noted by the user 200 who desires to transfer the first profile may be stored in the first terminal 210 or the first profile.

The information on the first profile may include, for example, a name and a logo of a business operator 250, a profile policy, etc. The information to be noted by a user who desires to transfer the first profile may include, for example, the remaining number of times of profile transfer allowed by the business operator 250, costs to be paid by the user 200 for profile transfer, or the like. According to an embodiment, the information on the first profile may include a device change configuration, and may include the contents requiring acquisition of information of the second terminal 220 to which the profile is to be transferred, or may include identification information indicating that the corresponding profile is deleted for the device change, whether a device change is provided, etc. The information of the second terminal 220 may selectively include at least one of an eUICC identifier installed in the second terminal 220, a type allocation code (TAC) of the second terminal 220, and information of the opening mediation server (not shown) supported by the second terminal 220. The information of the opening mediation server supported by the second terminal 220 may include an FQDN of an address of at least one opening mediation server and an indicator indicating whether the corresponding opening mediation server supports a push notification. In addition, at least one address of a profile server to which the terminal needs to be connected for profile transfer may be stored in the first profile. The profile server to which the terminal needs to be connected for profile transfer may be, for example, the profile server 230.

In operation 3012, when the corresponding first profile supports the device change and has an activation code stored for device change processing, the first terminal 210 may prepare the corresponding activation code. If necessary, the first terminal 210 may configure an activation code to be used for profile downloading in the second terminal 220 by using device change information in the activation code used for profile downloading. In addition, when the activation code is stored in the profile, the corresponding value may be processed first.

In the previous procedure, in determining, by the first terminal 210, that changing and installation processing for the first profile is possible, through information collected and stored in the profile and the first terminal 210, an LPA (not shown) of the first terminal 210 may transmit, in operation 3015, a command for deleting the corresponding first profile to an eUICC (not shown), cause the eUICC (not shown) to process the state the corresponding selected first profile as a deleted state, or perform processing of changing the state to an unusable state, and then generate and prepare a notification for a result of the processing. According to an embodiment, the processing of the changing the state to an unusable state may be performed so that the state of the first profile in the eUICC remains the same, and access to a state change of the corresponding profile is controlled by the first terminal 210 if necessary.

In operation 3018, the first terminal 210 may transmit, to the profile server 230, a notification on the processing of profile deletion or changing to an unusable state. In operation 3021, the first terminal 210 may receive a normal response from the profile server 230.

In a case where the corresponding first profile deletion or unusable command is received, the profile server 230 may identify whether the profile corresponds to a profile supporting a device change, and may make a configuration so that a second profile substituting the first profile can be downloaded or the previously installed first profile can be downloaded again when the profile corresponds to a profile supporting a device change and profile downloading is performed in operation 3029 in the second terminal 220.

In operation 3023, the first terminal 210 may notify to the user 200 or the second terminal 220 that an activation code enabling downloading of the second profile (or the first profile) is prepared. For example, when the first terminal 210 receives a normal response from the profile server 230, the first terminal 210 may display and provide the activation code so that the second terminal 230 can use the same. This may be an activation code in a QR code format, but may be a protocol used for message transmission between the first terminal 210 and the second terminal 230. As an example of transferring the activation code from the first terminal 210 to the second terminal 220, the first terminal 210 may convert the activation code into an image format such as a QR code or convert the same into a character string format, output the same on a screen, and notify to the user 200 that the activation code is prepared. The user 200 may input, to the second terminal 220, the activation code output on the screen of the first terminal 210.

For example, in operation 3023, the first terminal 210 may output, on the screen, that the activation code for the second profile has been prepared, or may transfer the activation code to the second terminal 220 through connection such as wired connection, Wi-Fi, Bluetooth™, and NFC.

In operation 3026, according to an embodiment of the disclosure, an activation code configured in a QR code is described. When the QR code is displayed on a user screen or is prepared in a format transmittable to the second terminal 220 even though the QR code is not displayed, corresponding activation code information may be input to the second terminal 220. For example, this may be a method in which in a case of the QR code format, the user 200 scans the QR code displayed on the first terminal 210 by using the second terminal 220 according to a user guide message displayed on the first terminal 210 or the second terminal 220, and receives the activation code. When the LPA (not shown) of the second terminal 220 receives the activation code from the first terminal 210, the second terminal 220 may start a profile download procedure.

In operation 3029, the second terminal 220 may perform the profile download procedure by using the input activation code. The activation code may include an FQDN of an address of the profile server 230 in which the second profile is stored, an event identifier (MatchingID) connected to the second profile, etc. In addition, the profile server 230 may include, in the activation code, an FQDN of an address of the opening mediation server (not shown) for which event registration is completed. At a specific time point before preparing the activation code for the second profile, for example, in operation 3005, when events are registered in one or more opening mediation servers (not shown), the profile server 230 may include, in the activation code, FQDNs of addresses of the one or more opening mediation servers, or may select an FQDN of an address of one opening mediation server and include the same.

In operation 3029, the second terminal 220 may request profile downloading from the profile server 230. Operation 3029 may be performed by using one or more of an authentication initiation (initiate authentication) message and a terminal authentication request (authenticate client) message, and may be performed by further transmitting an operation type configured as profile downloading.

In operation 3029, in a process of processing profile downloading, the profile server 230 may additionally verify whether the activation code token value is a token value previously issued by the profile server in operation 3005, or the activation code used by the first terminal 210 for profile downloading in operation 3005, or is reusable. In addition, it is also possible to identify whether the first profile deletion or usable state change notification is normally received from the first terminal 210 to determine whether to release the first profile or the second profile prepared to substitute the first profile to download the same in the second terminal 230. In addition, in operation 3029, if necessary, the profile server 230 may identify again, from the operator 250, whether the first profile is transferrable. For example, operation 3029 may be performed by using a profile transfer confirmation request message (confirm device change request) requesting, from the operator 250, the confirmation of whether the profile is transferrable, requested by the first terminal 210 from the profile server 230. The profile transfer configuration request message may include a profile identifier of the requested first profile, may also selectively include at least one of an eUICC identifier installed in the second terminal 220 and a type allocation code (TAC) of the second terminal 220. In operation 3029, the operator 250 having received the profile transfer confirmation request message from the profile server 230 may identify the requested profile by using the profile identifier, and determine whether the corresponding profile is transferrable. In addition, whether the profile server 230 can reuse the same profile as the first profile or a new profile needs to be prepared during the transfer to the second terminal 220 may be determined, and a result of the determination may be transmitted to the profile server 230 as a response.

In operation 3029, whether the first profile is transferrable may be autonomously determined by the profile server 230 without interworking with the operator 250. In this case, the operator 250 may provide a configuration on transfer of the first profile to the profile server 230 before operations 3001 or 3029, and the profile server 230 may store the same. The profile server 230 may identify the profile requested to be transferred, by using the profile identifier, and may determine whether the corresponding profile is transferrable. In addition, whether the profile server 230 can reuse the same profile as the first profile or a new profile needs to be prepared during the transfer to the second terminal 220 may be determined. In addition, the profile server 230 may determine whether the first profile needs to be deleted before the second profile for the second terminal 220, to be prepared in the profile server 230 for transfer of the first profile, is transferred to the second terminal 220.

As described above, in operation 3029, when the second terminal 220 process the profile downloading, the second terminal 220 may transmit, to the profile server 230, a message requesting profile downloading as described in operation 3003 above. For example, the request for the profile downloading in operation 3029 may be performed by using a terminal authentication request message (authenticate client request) including at least one of an identifier (eUICC ID (EID)) of the eUICC in the second terminal 220 and a matching identifier corresponding to the prepared profile. In operation 3029, the profile server 230 may provide the second terminal 220 with the second profile corresponding to the matching identifier or the identifier of the eUICC. For example, operation 3029 may further include exchanging of messages one or more times between the second terminal 220 and the profile server 230, and a message initially transmitted as a response to the second terminal 220 by the profile server 230 may be a terminal authentication response message (authenticate client response).

If necessary, the profile server 230 may additionally verify one or more of whether the first terminal 210 has received a notification on whether the state of the corresponding first profile is changed to a deleted or unusable state, whether a device change is allowed upon information on profile 1, and whether the second terminal 220 has suggested the activation code provided or allowed by the profile server 230 for the device change, at a specific time point before operation 3029, and may allow the second terminal 220 to download the profile, or respond with a downloading error message, so as to terminate the procedure.

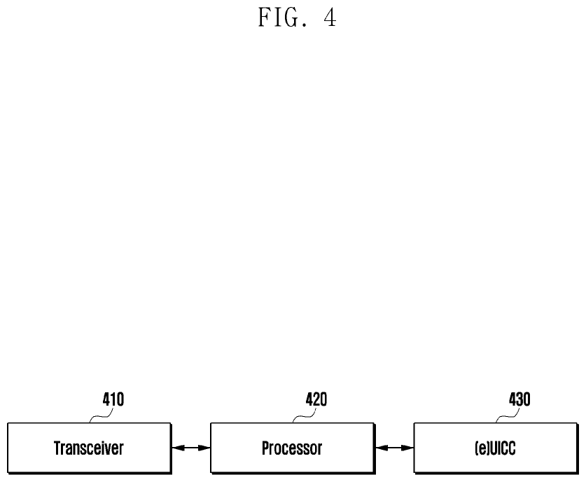

FIG. 4 illustrates a terminal according to an embodiment of the present disclosure.

The terminals (the first terminal 210, the second terminal 220, and the terminal described with no reference numeral) described in the disclosure may correspond to the first terminal and the second terminal described with reference to FIG. 2. The first terminal 210 and the second terminal 220 may be an embodiment of the terminal in FIG. 2, and the expressions “first” and “second” are merely used to indicate that respective terminals are physically different terminals.

As illustrated in FIG. 4, the terminal may include a transceiver 410 and a processor 420. Furthermore, the terminal may also include a UICC 430. For example, the (e)UICC 430 may be inserted into the terminal or may be an (e)UICC embedded in the terminal.

The transceiver 410 may transmit and receive signals, information, data, etc. to and from a profile server.

The transceiver 410 according to an embodiment of the disclosure may transmit a message requesting transfer of a profile to a profile server, receive a profile transfer confirmation code required indicator from the profile server, transmit a profile transfer confirmation code to the profile server, receive, from the profile server, an activation code, whether an event is registered in an opening mediation server, and whether a profile needs to be deleted, and transmit a result of the deletion of the profile to the profile server.

The transceiver 410 according to an embodiment of the disclosure may transmit, to the profile server, a message to request a profile by using an activation code, and may receive a profile package.

The transceiver 410 according to an embodiment of the disclosure may receive a profile package including predetermined information on device change processing or receive a response message while transmitting a message notifying a profile server of device change information to be used later for a device change and/or supporting a device change by using an activation code.

The processor 420 is an element that generally controls the terminal. The processor 420 may control an overall operation of the terminal according to various embodiments of the disclosure. The processor 420 may be referred to as a controller. According to an embodiment of the present disclosure, the processor 420 may include at least one processor.

The processor 420 according to an embodiment of the disclosure may control the terminal to receive an input of profile installation from a user, receive an input of an activation code for the profile installation from the user, receive a response message or profile information of a profile package received from a profile server, determine whether the received profile information or response message includes information on reuse of the activation code for a device change or an activation code to be newly used, perform processing so that the corresponding information to be stored in a storage (not shown), receive an input of a profile transfer request, identify profile transfer information, configure an activation code for downloading and installing of the profile in another terminal, determine whether a deleted or unusable state of the existing profile is required in configuring the activation code, perform processing of changing of the state if required, transfer a result of the corresponding processing to the transceiver 410, identify a response value to the result of the processing from the transceiver 410, and transfer the activation code or profile transfer preparation completion to another terminal.

The processor 420 according to an embodiment of the disclosure may control the terminal to receive an activation code transferred from another terminal, transmit a message requesting a profile to a profile server by using the activation code, receive a profile package from the profile server, and install the profile package. The UICC 430 according to an embodiment of the disclosure may download a profile and install the profile. Furthermore, the UICC 430 may manage the profile.

The processor 420 according to an embodiment of the disclosure may perform control to transmit, to a profile server through the transceiver 410, a message including capability information indicating whether a device change function is supported, receive, from the profile server through the transceiver 410, metadata including a device change configuration when it is identified that the terminal supports a device change, based on the capability information indicating whether the device change function is supported.

The processor 420 according to an embodiment of the disclosure may perform control to store a new activation code in a storage (not shown) when the device change configuration includes new activation code information and information indicating storage of the new activation code information.

In this case, the capability information indicating whether the device change function is supported corresponds to eUICC capability of the terminal.

The device change configuration includes information indicating reuse of a pre-stored activation code.

The processor 420 according to an embodiment of the disclosure may perform control to receive, from the profile server through the transceiver 410, metadata including a device change configuration when version information of an eUICC installed in the terminal corresponds to specific version information and it is identified that the terminal supports a device change, based on the capability information indicating whether the device change function is supported.

In this case, the version information of the eUICC may be included in the message or included again in a message and may be transmitted from the terminal to the profile server, or may be identified by the profile server, based on at least one piece of information included in the message transmitted from the terminal.

The UICC 430 may operate upon the control of the processor 420. Alternatively, the UICC 430 may include a processor or controller for installing a profile, or an application may have been installed in the UICC. A part of the application may have been installed in the processor 420.

The terminal may further include a storage unit (not shown), and may store data, such as a basic program, an application program, or configuration information for an operation of the terminal. The storage (not shown) according to an embodiment of the disclosure may further store a user input or an activation code received from a profile server. In addition, the storage unit may include at least one storage medium among a flash memory type, a hard disk type, a multimedia card micro type, a card type memory (e.g., an SD or XD memory), a magnetic memory, a magnetic disk, an optical disk, a random access memory (RAM), a static random access memory (SRAM), a read-only memory (ROM), a programmable read-only memory (PROM), or an electrically erasable programmable read-only memory (EEPROM). Furthermore, the processor 420 may perform various operations by using various programs, contents, data, etc. stored in the storage unit.

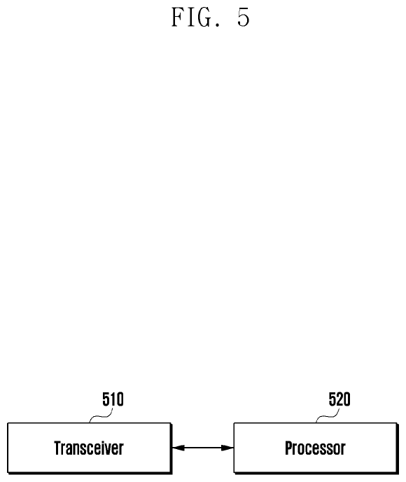

FIG. 5 illustrates a profile server according to an embodiment of the present disclosure.

The profile servers (the first profile server 230, the second profile server 240, and the server described with no reference numeral) described in the disclosure may correspond to the profile server described with reference to FIG. 2. The first profile server 230 and the second profile server 240 may be an embodiment of the server in FIG. 2, and the expressions “first” and “second” are merely used to indicate that respective profile servers are physically different profile servers.

Referring to FIG. 5, the profile server may include a transceiver 510 and a processor 520.

The transceiver 510 may transmit and receive signals, information, data, etc. to and from a terminal, an opening mediation server, or an operator.

The transceiver 510 according to an embodiment of the disclosure may receive a profile download request message from a terminal, receive an activation code from the terminal, transmit a profile package to the terminal in a state in which a profile can be downloaded, transmit an error code to the terminal in a state in which a profile cannot be downloaded, transmit a new activation code or transmit a message including whether an activation code suggested by the existing terminal needs to be stored, to reinstall the profile in another terminal, and transmit, to another terminal, information on whether the state of the existing profile needs to be changed to a deleted/unusable state for reinstallation of the profile.

In addition, the transceiver 510 according to an embodiment of the disclosure may receive a profile transfer request message, transmit a profile transfer confirmation code required indicator to a terminal, receive a profile transfer confirmation code to the terminal, receive a profile deletion or unusable message from the terminal, receive a profile download request message from another terminal, transmit a profile package to another terminal in a state in which the profile can be downloaded, and transmit an error code to another terminal in a state in which the profile cannot be downloaded.

The processor 520 is an element for generally controlling the profile server. The processor 520 may control an overall operation of the profile server according to various embodiments of the disclosure. The processor 520 may be referred to as a controller. According to an embodiment of the disclosure, the processor 520 may include at least one processor.

The processor 520 according to an embodiment of the disclosure may perform control to identify an activation code received from a terminal to determine whether the activation code is reusable for transfer of a profile matched to the activation code to another terminal, determine received eUICC version information to respond to the terminal with a message storing the previously transmitted activation code, respond by generating a new activation code, or perform processing to configure a profile by including predetermine information for a device change in information on a profile for processing downloading, i.e., metadata or an elementary file, and transmit the same to the terminal through the transceiver 510. In addition, the processor may control a profile server to determine whether a profile is transferrable by using a profile transfer request message received at a specific time point from a terminal, transmit a profile transfer confirmation code required indicator to the terminal, receive a profile transfer confirmation code from the terminal, configure the state of a prepared profile as an downloading impossible state when the existing profile needs to be deleted, transmit, to the terminal, an activation code and a message including whether the state of the profile needs to be changed to a deleted or unusable state, receive, from the terminal, a result of the profile deletion or unusable state processing, change the state of the same profile as the profile downloaded in the terminal or a profile substituting the profile so that the profile can be downloaded in another terminal, receive a profile download request message from the terminal, determine whether the state of the profile is a downloadable state, transmit a profile package to another terminal in a state where the profile can be downloaded, and transmit an error code to another terminal in a state where the profile cannot be downloaded.

The processor 520 according to an embodiment of the disclosure may perform control to receive, from a terminal through the transceiver 510, a message including capability information indicating whether a device change function is supported, identify that the terminal supports a device change, based on the capability information indicating whether the device change function is supported, and transmit, to the terminal through the transceiver, metadata including a device change configuration when it is identified that the terminal supports the device change.

In this case, the device change configuration includes new activation code information and information indicating storage of the new activation code.

The capability information indicating whether the device change function is supported corresponds to eUICC capability of the terminal.

The device change configuration includes information indicating reuse of a pre-stored activation code.

The processor 520 according to an embodiment of the disclosure may identify version information of an eUICC installed in the terminal, and transmit, to the terminal through the transceiver 510, metadata including a device change configuration when the version information of the eUICC corresponds to specific version information and it is identified that the terminal supports a device change, based on the capability information indicating whether the device change function is supported.

In this case, the version information of the eUICC may be included in the message or included again in a message and may be received from the terminal, or may be identified, based on at least one piece of information included in the message received from the terminal.

The profile server may further include a storage unit (not shown), and store data, such as a basic program, an application program, or setting information for an operation of the profile server. In addition, the storage may include an activation code for a profile device change according to an embodiment of the disclosure. In addition, the storage unit may include at least one storage medium among a flash memory type, a hard disk type, a multimedia card micro type, a card type memory (e.g., an SD or XD memory), a magnetic memory, a magnetic disk, an optical disk, a random access memory (RAM), a static random access memory (SRAM), a read-only memory (ROM), a programmable read-only memory (PROM), or an electrically erasable programmable read-only memory (EEPROM). Furthermore, the processor 520 may perform various operations by using various programs, content, data, etc. stored in the storage unit.

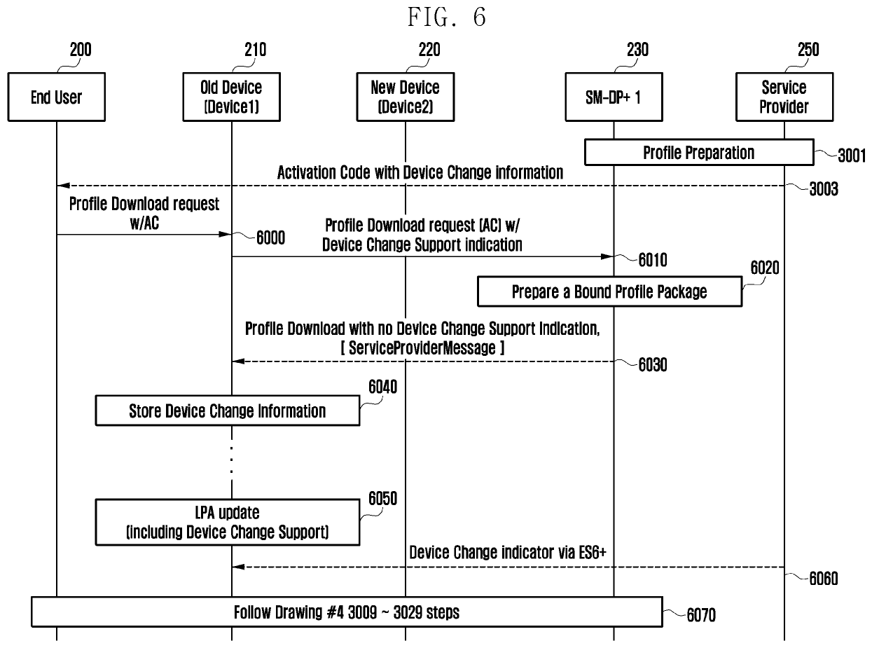

FIG. 6 illustrates a method for determining whether an activation code is stored and perform processing in a case of performing updating by a first terminal so that a device change is supported according to an embodiment of the present disclosure.

In FIG. 6, the configuration and description of a user 200, a first terminal 210, a second terminal 220, a profile server 230, and an operator 250 refer to FIG. 2. For example, the user 200, the first terminal 210, the second terminal 220, the profile server 230, and the operator 250 may correspond to the user 200, the first terminal 210, the second terminal 220, the first profile server 230, and the operator 250, respectively.

In FIG. 6, the description of operations 3001 and 3003 refers to the description of the corresponding operations in the embodiment described with reference to FIG. 3.

Operations 6000, 6010, 6020, and 6030 correspond to an example indicating processing in a case where an activation code suggested by the first terminal 210 for profile downloading includes information on a device change support in the description of operation 3005 in FIG. 3, but the profile server 230 cannot determine a device change support through the corresponding received activation code and/or information on a support function and versions of the LPA and the eUICC of the first terminal 210.

In operation 6000, the user 200 may input an activation code including a device change support, acquired from the operator 250 or the profile server 230, to the first terminal so as to enable the first terminal 210 to request profile downloading from the profile server 230. As described in operation 3005 in FIG. 3 above, in operation 6010, the first terminal 210 may transmit a profile download request to the profile server 230 by including a device change support indicator (device change support indication) in the profile download request. The first terminal 210 may transmit device info and eUICC info to the profile server 230 by including a device change function support indication in the device info and eUICC info.

In operation 6020, the profile server 230 having received the same may determine whether to configure a response message or profile information including information on a device change, based on one or more of a combination of versions (indicated as “v version number”) of the LPA and the eUICC installed in the first terminal 210, whether a device change function is supported, and whether profile information including device change information can be configured in real time.

In operation 6030, as a result of the determination above, when downloading the prepared profile in the first terminal 210 (operation 6030), the profile server 230 may download the profile in the first terminal 210 by not including a device change support indicator in the response message or the profile information. A case where the profile is downloaded by not including the device change support indicator may be one of cases of “not supported” in the device change information response column in [Table 1] below. For reference, in [Table 1] below, for example, the first row indicates a case a device change support with LPA version 3 and a device change support with eUICC version 3. In addition, the case where the profile is downloaded by not including the device change support indicator may correspond to a case where even in the first row case where versions of both the LPA and the eUICC correspond to version 3 and the device change is supported, when the device change information cannot be included in the profile information in real time and cannot be download, a profile package may be downloaded without including the device change information.

TABLE 1
Device change information response according to LPA and
eUICC versions and whether device change is supported

| | | | Device change |
|---|---|---|---|
| | LPA | eUICC | information response |
| Version | Device change | Device change | Supported: profile |
| 3 | supported | supported | information (metadata or |
| | | | profile property file |
| | | | (e.g., EF_{DCC} under |
| | | | DF_{GSMA}) etc.₎, or included |
| | | | in response message during |
| | | | profile downloading |
| | Device change | Device change | Not supported, or supported |
| | supported | not supported | in the form of indicating |
| | | | storage of used activation |
| | | | code (corresponding to v2 |
| | | | LPA device change support |
| | | | case) |
| | Device change | Device change | Not supported |
| | not supported | supported | |
| | Device change | Device change | Not supported |
| | not supported | not supported | |
| Version | Device change | Device change | Supported: indication of |
| 2 | supported | not supported | storage of used activation |
| | | | code |
| | Device change | Device change | Not supported |
| | not supported | not supported | |

The terminal having downloaded the profile package may additionally determine whether there is included device change information, and complete the profile downloading without performing an additional operation of storage of device change information when the corresponding information is not included. When the eUICC supports a device change and the activation code received for the profile downloading includes device change support information in the profile server 230, the profile server 230 may additionally notify to the user 200 that a device change is possible at the time of LPA updating later, and may configure a service provider message recommending storage of the activation code having been used when the user 200 performs the profile downloading, and respond with the configured service provider message.

In operation 6040, when the device change information storage indicator has failed to be received, the first terminal 210 may display the above-configured service provider message to the user 200, receive an input of whether to store, and store the activation code. Alternatively, even in a case whether there is no service provider message, according to a configuration of the first terminal 210, it may be possible to receive, from the user 200, an additional input of whether to store the used activation code in the first terminal 210, and store the same.

In operation 6050, at a specific time point after a time point at which the first profile is downloaded in the first terminal 210, the first terminal 210 may perform updating so that the LPA (not shown) of the first terminal 210 support a device change. In addition, when the profile downloading is processed by not including the device change information in the profile information of the previously downloaded first profile (operation 6030), in operation 6060, the service provider 250 may download information for the device change, which can be provided in operation 3005 described in the example of FIG. 3 in an elementary file (e.g., EFDCC under DFGSMA) of the first profile by using an ES6+ interface. It is illustrated that operation 6060 is performed after operation 6050, but operation 6060 may be a specific time point before an activation code for transfer of the first profile (or the second profile) is generated and provided to another terminal 220 (corresponding to operation 3012 in operation 670) after operation 6030.

A description of operation 6070 refers to the description and procedure after operation 3009 in the example of FIG. 3 above, and thus an additional description thereof is omitted.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments, but should be defined by the appended claims and equivalents thereof.

It should be appreciated that various embodiments of the disclosure and the terms used therein are not intended to limit the technological features set forth herein to particular embodiments and include various changes, equivalents, or alternatives for a corresponding embodiment. With regard to the description of the drawings, similar reference numerals may be used to designate similar or relevant elements. A singular form of a noun corresponding to an item may include one or more of the items unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “a first,” “a second,” “the first,” and “the second” may be used to simply distinguish a corresponding element from another, and does not limit the elements in other aspect (e.g., importance or order). It is to be understood that if an element (e.g., a first element) is referred to, with or without the term “operatively” or “communicatively,” as “coupled with/to” or “connected with/to” another element (e.g., a second element), it means that the element may be coupled/connected with/to the other element directly (e.g., wiredly), wirelessly, or via another element (e.g., a third element).

As used herein, the term “module” may include a unit implemented in hardware, software, or firmware, and may be interchangeably used with other terms, for example, “logic,” “logic block,” “component,” or “circuit.” The “module” may be a minimum unit of a single integrated component adapted to perform one or more functions, or a part thereof. For example, according to an embodiment, the “module” may be implemented in the form of an application-specific integrated circuit (ASIC).

Various embodiments of the disclosure may be implemented as software (e.g., a program) including one or more instructions that are stored in a storage medium (e.g., an internal memory or external memory) that is readable by a machine (e.g., a computer). The machine refers to a device that can invoke the stored instructions from the storage medium and operate according to the invoked instructions, and may include terminals (e.g., the first terminal 210 and the second terminal 220) according to various embodiments of the disclosure. When the instructions are executed by a processor (e.g., the processor 520 of FIG. 9 or the processor 620 of FIG. 10), the processor may perform functions corresponding to the instructions, with or without using one or more other components under the control of the processor. The instructions each may include a code generated by a complier or a code executable by an interpreter.

The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the above-described sub elements may be omitted, or other sub elements may be added to various embodiments. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a server, the method comprising:
receiving, from a terminal, an embedded universal integrated circuit card (eUICC) information indicating whether a device change is supported;
determining that the terminal supports the device change based on the eUICC information; and
transmitting metadata comprising a device change configuration to the terminal based on determining that the terminal supports the device change.

2. The method of claim 1, wherein the device change configuration comprises at least one of new activation code and information indicating a use of the new activation code.

3. The method of claim 1, wherein the device change configuration comprises information indicating a use of a stored activation code.

4. The method of claim 1, wherein transmitting the metadata comprises:
identifying version information of an eUICC installed in the terminal, and
transmitting, to the terminal, the metadata comprising the device change configuration in case that the version information of the eUICC corresponds to specific version information and supporting the device change by the terminal is identified based on the eUICC information; and
wherein:
the version information of the eUICC, received from the terminal, is included in a message or other messages, or
the version information of the eUICC is identified based on at least one piece of information included in the message received from the terminal.

5. A method of a terminal, the method comprising:
transmitting, to a server, an embedded universal integrated circuit card (eUICC) information indicating whether a device change is supported; and
receiving, from the server, metadata comprising a device change configuration based on determining that the terminal supports device change, wherein that the terminal supports the device change is determined based on the eUICC information.

6. The method of claim 5, further comprising storing a new activation code in case that the device change configuration comprises at least one of new activation code and information indicating a use of the new activation code.

7. The method of claim 5, wherein the device change configuration comprises information indicating a use of a stored activation code.

8. The method of claim 5, wherein receiving the metadata comprises receiving, from the server, the metadata comprising the device change configuration in case that version information of an eUICC installed in the terminal corresponds to specific version information and supporting the device change is identified based on the eUICC information, and
wherein:
the version information of the eUICC, received from the terminal, is included in a message or other messages, or
the version information of the eUICC is identified, by the server, based on at least one piece of information included in the message transmitted from the terminal.

9. A server comprising:
a transceiver; and
at least one processor operably coupled to the transceiver, the at least one processor configured to:
receive, from a terminal through the transceiver, an embedded universal integrated circuit card (eUICC) information indicating whether a device change is supported,
determine that the terminal supports the device change based on the eUICC information, and
transmit, to the terminal through the transceiver, metadata comprising a device change configuration based on determining that the terminal supports the device change.

10. The server of claim 9, wherein the device change configuration comprises at least one of new activation code and information indicating a use of the new activation code.

11. The server of claim 9, wherein the device change configuration comprises information indicating a use of a stored activation code.

12. The server of claim 9, wherein the at least one processor is further configured to:
identify version information of an eUICC installed in the terminal, and
transmit, to the terminal via the transceiver, the metadata comprising the device change configuration in case that the version information of the eUICC corresponds to specific version information and supporting the device change by the terminal is identified based on the eUICC information, and
wherein:
the version information of the eUICC, received from the terminal, is included in a message or other messages, or
the version information of the eUICC is identified based on at least one piece of information included in the message received from the terminal.

13. A terminal comprising:
a transceiver; and
at least one processor operably coupled to the transceiver, the at least one processor configured to:
transmit, to a server through the transceiver, an embedded universal integrated circuit card (eUICC) information indicating whether a device change is supported, and
receive, from the server through the transceiver, metadata comprising a device change configuration based on determining that the terminal supports device change, wherein whether the terminal supports the device change is determined based on the eUICC information.

14. The terminal of claim 13, wherein the at least one processor is further configured to store a new activation code in case that the device change configuration comprises at least one new activation code and information indicating a use of the new activation code.

15. The terminal of claim 13, wherein the device change configuration comprises information indicating a use of a stored activation code.

16. The terminal of claim 13, wherein the at least one processor is further configured to receive, from the server, the metadata comprising the device change configuration in case that version information of an eUICC installed in the terminal corresponds to specific version information and supporting the device change is identified based on the eUICC information, and
Wherein:
the version information of the eUICC, received from the terminal, is included in a message or other messages, or
the version information is identified, by the server, based on at least one piece of information included in the message transmitted from the terminal.
